(19) United States
(12) Patent Application Publication
(10) Pub. No.: US 2023/0393946 A1
(43) Pub. Date: Dec. 7, 2023

(54) SELF-SUFFICIENT ENCRYPTED DATABASE BACKUP FOR DATA MIGRATION AND RECOVERY

(71) Applicant: SAP SE, Walldorf (DE)

(72) Inventors: Subhamay BARUI, West Bengal (IN); Ramesh GUPTA, Pune (IN)

(21) Appl. No.: 17/805,522

(22) Filed: Jun. 6, 2022

(51) Int. Cl. G06F 11/14; H04L 9/08

(52) U.S. Cl. CPC G06F 11/1451; G06F 11/1469; H04L 9/0822; H04L 9/0825

(57) ABSTRACT

Embodiments are described for a system comprising a first database server comprising a first master database and a first user database and a second database server comprising a second master database and a second user database. The first database server is configured to select one or more encryption keys from the first master database and the first user database; generate a database backup file based on data content of the first user database and the one or more encryption keys, wherein the data content is encrypted by at least one data encryption key of the one or more encryption keys. The first database server is further configured to encrypt the one or more encryption keys with asymmetric keys or passwords and transmit the database backup file to the second database server.

### BACKGROUND

A database server may save backup files or take dumps for databases within the database server for various purposes. For example, the database server can save the backup files for disaster recovery. When a database server crashes and data in the database server is lost, the database server can recover the data by loading the backup files of a prior stable version of the database server. For another example, one or more databases in the database server may be corrupted. In such a case, the database server can restore data of the one or more databases using the backup files. The database server can also send the backup files to another database server to migrate data to different physical and/or virtual locations.

### SUMMARY

Some aspects of this disclosure relate to apparatus, system, computer program product, and method embodiments for implementing a self-sufficient encrypted database backup for data migration and recovery.

Some embodiments of this disclosure provide a system comprising a first database server comprising a first master database and a first user database and a second database server comprising a second master database and a second user database. The first database server is configured to select one or more encryption keys from the first master database and the first user database; generate a database backup file based on data content of the first user database and the one or more encryption keys, wherein the data content is encrypted by at least one data encryption key of the one or more encryption keys; and transmit the database backup file to the second database server. The second database server is configured to receive the database backup file from the first database server; decrypt the data content of the first user database using the at least one data encryption key; and generate data content of the second user database based on the one or more encryption keys and the decrypted data content of the first user database.

Some embodiments of this disclosure provide a database server comprising a memory configured to store a master database and a user database and at least one processor coupled to the memory. The at least one processor is configured to select one or more encryption keys from the master database and the user database and encrypt the one or more encryption keys. The at least one processor is also configured to generate a database backup file based on data content of the user database and the encrypted one or more encryption keys, wherein the data content is encrypted by at least one data encryption key of the one or more encryption keys and store the database backup file in the memory.

Some embodiments of this disclosure provide a database server comprising a memory configured to store a master database and a user database and at least one processor coupled to the memory. The at least one processor is configured to receive a database backup file, wherein the database backup file includes data content and one or more encryption keys of a prior version of the database server or a second database server, wherein the data content is encrypted by at least one data encryption key of the one or more encryption keys and decrypt the data content using the at least one data encryption key of the one or more encryption keys. The at least one processor is also configured to generate an updated data content of the user database based on the one or more encryption keys and the decrypted data content and store the updated data content in the user database.

This Summary is provided merely for the purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing self-sufficient encrypted database backup, according to some embodiments of the disclosure.

FIG. 2 illustrates a block diagram of an example system of a device for self-sufficient encrypted database backup, according to some embodiments of the disclosure.

FIG. 3 illustrates an example of a key hierarchy structure of a database server, according to embodiments of the disclosure.

FIG. 4 illustrates an example of a database backup file, according to embodiments of the disclosure,

FIG. 5 illustrates an example method for saving a database backup file, according to embodiments of the disclosure.

FIG. 6 illustrates an example method for loading a database backup file, according to embodiments of the disclosure.

FIG. 7 is an example computer system for implementing some embodiments of the disclosure or portion(s) thereof.

The present disclosure is described with reference to the accompanying drawings. In the drawings, generally, like reference numbers indicate identical or functionally-similar elements. Additionally, generally, the left-most digit(s) of a reference number identifies the drawing in which the reference number first appears.

### DETAILED DESCRIPTION

Some embodiments of this disclosure include apparatus, system, computer program product, and method embodiments for implementing a self-sufficient encrypted database backup for data migration and recovery.

In some embodiments, a database server may include one or more databases, which store data. The database server may generate database backup files that include the data of the one or more databases regularly. The database backup files can be used to recover the database server in a crash or restore the one or more databases when the data is corrupted. The database server can also migrate the data to another database server by sending the database backup files to the other database server.

In some embodiments, a third party may obtain the data stored in the one or more databases of the database server. For example, the third party may invade the database server adversely to obtain the data. The third party may also receive the data accidentally when the database server sends the data to the other database server. To protect the data, the database server may encrypt the data with one or more encryption keys.

In some embodiments, the database server may generate a database backup file for a user database of the database server. The database backup file includes data stored in the user database. However, the data of the user database may be encrypted by one or more external encryption keys outside the user database. For example, the data of the user database can be encrypted by a database encryption key (DEK) of a master database of the database server. The data of the user database may also include one or more internal encryption keys that are used to further encrypt the data of the user database. The one or more internal encryption keys may also be encrypted by a master key of the master database or other encryption keys outside the user database. Therefore, when the database backup file is used to recover the user database or migrate the data to the other database server, the data cannot be decrypted without the one or more encryption keys outside the user database. However, the one or more external encryption keys may not be included in the database backup file because they are not a part of the data stored in the user database. This makes the database backup file unusable. For example, the database server may attempt to recover the user database using the database backup file. The database server may retrieve the DEK from the master database. However, the DEK may have been rotated since the database backup file was generated and thus cannot be used to decrypt the user database data in the database backup file. In other embodiments, when the database backup file is sent to the other database server, the other database server may not have an access to the master database of the database server and therefore cannot obtain the DEK of the master database to decrypt the database backup file.

In some embodiments, the database backup file may be configured to include the one or more external encryption keys outside the user database. In such a case, the database server or the other database server can retrieve the one or more external encryption keys from the database backup file and decrypt the data of the user database. On the other hand, the third party who obtains a copy of the database backup file can also decrypt the data of the user database in the same way, which creates a security issue.

In some embodiment, the one or more external encryption keys can be encrypted using asymmetric cryptography or a password. The database server may decrypt the one or more external encryption keys using a private key of the asymmetric cryptography or the password. Whereas the third party may not be able to decrypt the one or more external encryption keys without the private key or the password. In such a case, the database backup file can be securely stored and efficiently used.

These and other features of example embodiments will now be discussed in greater detail with respect to the corresponding figures.

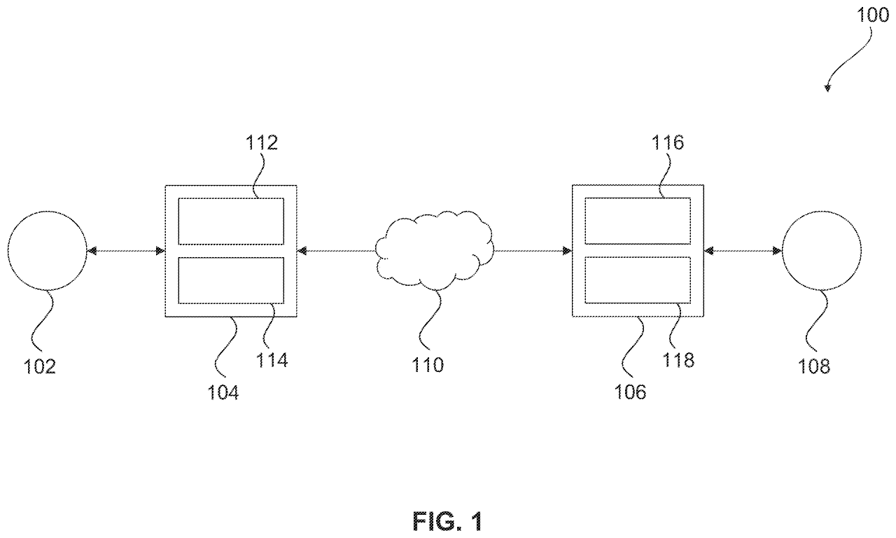

FIG. 1 illustrates an example system 100 implementing the self-sufficient encrypted database backup, according to some embodiments of the disclosure. The example system 100 is provided for the purpose of illustration only and does not limit the disclosed embodiments. The example system 100 may include, but is not limited to, users 102 and 108, and database servers 104 and 106. The user 102 may operate the database server 104 and the user 108 may operate the database server 106. The users 102 and 108 can be different users or a same user. The database server 104 can include a master database 112 and a user database 114, Similarly, the database server 106 can include a master database 116 and a user database 118. In some embodiments, the database server 104 connects with the database server 106 via a connection 110, The connection 110 can be a wired connection, a wireless connection, an internal connection, a bus connection, a virtual connection or other types of connections. In some embodiments, the connection 110 can be performed by the user 102, where the user 102 copies data of the database server 104 into a hard drive; carries the hard drive to a location of the database server 106; and copies the data of the database server 104 from the hard drive into the database server 106.

In some embodiments, the database server 104 can perform various database backup functions based on commands received from the user 102. For example, the database server 104 may generate a database backup file that includes data of the user database 114. The database server 104 may then send the database backup file to the database server 106 via the connection 110, When the database server 104 crashes or becomes corrupted, the user 102 can configure the database server 104 to retrieve the database backup file from the database server 106 via the connection 110 and recover the database server 104. In other embodiment, the database server 104 can be configured to store the database backup file locally in the database server 104. In such a case, when the user database 114 is corrupted, but other parts of the database server 104 are not impacted, the user 102 can configure the database server 104 to recover the user database 114 using the locally saved database backup file. In some embodiments, the connection 110 can be a cloud connection. The database server 104 may save the database backup file in a cloud storage of the connection 110 and retrieve it from the cloud storage when needed.

In some embodiments, the database server 104 can perform various migration functions based on commands received from the user 102. For example, the database server 104 can be configured to generate the database backup file and send it to the database server 106. On the other hand, the user 108 can configure the database server 106 to load data included in the database backup file into the user database 118. In such a case, the database server 104 can be referred to as a source database server and the database server 106 can be referred to as a target database server.

In some embodiments, a third party may obtain the database backup file when it is transmitted from the database server 104 to the database server 106; when it is transmitted from the database server 104 to the cloud storage of the connection 110; or when it is stored locally in the database server 104. Although data of the database backup file can be encrypted by one or more encryption keys, the third party may decrypt the data because the one or more encryption keys can also be included in the database backup file. For example, the database backup file can include data of the user database 114, which can be encrypted using a data encryption key (DEK) of the master database 112. In some embodiments, the database backup file can also include the DEK. Thus, the third party can retrieve the DEK from the database backup file and decrypt the data of the user database using the DEK.

In some embodiment, the one or more encryption keys can also be encrypted to prevent the third party from decrypting the data of the database backup file. For example, the user 102 can configure the database server 104 to encrypt the DEK from the master database 112 using a public key and include the encrypted DEK in the database backup file. For example, the user 102 can include the public key in an argument of a dump database (SQL) command to the database server 104, wherein the dump database command is used to configure the database server 104 to generate the database backup file. In such a case, the encrypted DEK can be decrypted using a private key that is paired with the public key. The user 102 can send the private key to the user 108 via a route different from the connection 110. For example, the user 102 can send the private key to the user 108 via a text message, an email, a phone call, an in-person conversation, etc. After receiving the private key, the user 108 can configure the database server 106 to load the database backup file using the private key. For example, the user 108 can include the private key in an argument of a load database (SQL) command. In such a case, the third party may not be able to decrypt the DEK and therefore may not decrypt the data of the user database 114 because it does not have the private key.

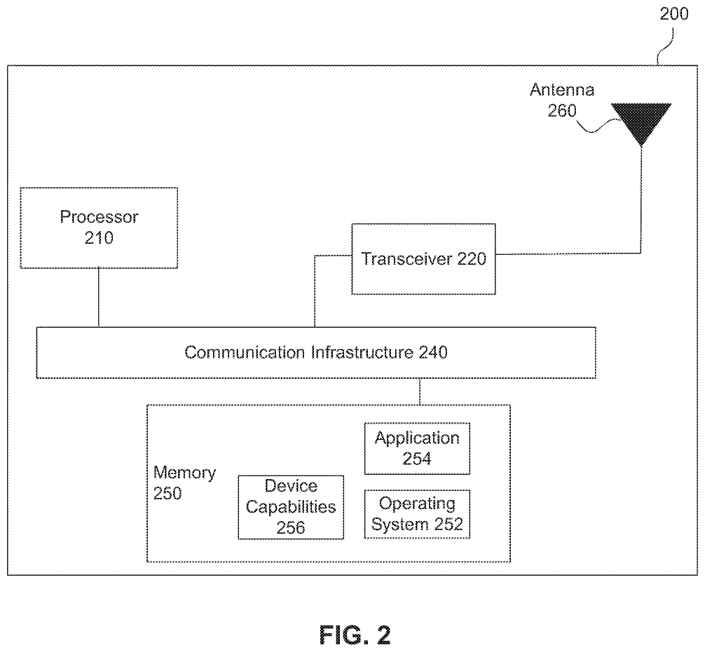

FIG. 2 illustrates an example system 200 of a device for the self-sufficient encrypted database backup, according to some embodiments of the disclosure. The example system 200 may be any of the devices (e.g., the database servers 104 and 106) of the example system 100, The example system 200 includes a processor 210, one or more transceivers 220, a communication infrastructure 240, a memory 250, an operating system 252, an application 254, device capabilities 256, and optional one or more antennas 260, Illustrated systems are provided as exemplary parts of example system 200, and example system 200 may include other circuit(s) and subsystem(s). Also, although components of example system 200 are illustrated as separate components, the embodiments of this disclosure may include any combination of these, e.g., less, or more components.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the one or more transceivers 220. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by the example system 200 and/or a user of example system 200. The applications in the application 254 may include applications such as, but not limited to, database management, radio streaming, video streaming, remote control, and/or other user applications. In some embodiments, the device capabilities 256 may be stored in the memory 250. For example, the device capabilities 256 include database sizes, computational complexity capabilities, processing speed, and other capabilities.

The example system 200 may also include the communication infrastructure 240, The communication infrastructure 240 provides communication between, for example, the processor 210, the one or more transceivers 220, and the memory 250. In some implementations, the communication infrastructure 240 may be a bus or a virtual connection.

The processor 210, alone, or together with instructions stored in the memory 250 performs operations enabling the example system 200 of the system 100 to implement the self-sufficient encrypted database backup, as described herein. Alternatively, or additionally, the processor 210 can be “hard coded” to implement mechanisms for the self-sufficient encrypted database backup, as described herein

The one or more transceivers 220 transmit and receive data from other devices. According to some embodiments, the one or more transceivers 220 may be coupled to antenna 260 to wirelessly transmit and receive the communication signals. Antenna 260 may include one or more antennas that may be the same or different types. The one or more transceivers 220 allow the example system 200 to communicate with other devices that may be wireless. In some embodiments, the one or more transceivers 220 may support wired communications with other devices. In such a case, the antenna 260 can be optional or removed. In some examples, the one or more transceivers 220 may include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some embodiments of this disclosure, the one or more transceivers 220 may include a cellular subsystem, a WLAN subsystem, and/or a Bluetooth™ subsystem, each including its own radio transceiver and protocol(s) as will be understood by those skilled in the arts based on the discussion provided herein. In some implementations, the one or more transceivers 220 may include more or fewer systems for communicating with other devices.

In some examples, the one or more the transceivers 220 may include one or more circuits (including a WLAN transceiver) to enable connection(s) and communication over WLAN networks such as, but not limited to, networks based on standards described in IEEE 802.11.

Additionally, or alternatively, the one or more the transceivers 220 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 220 may include a Bluetooth™ transceiver.

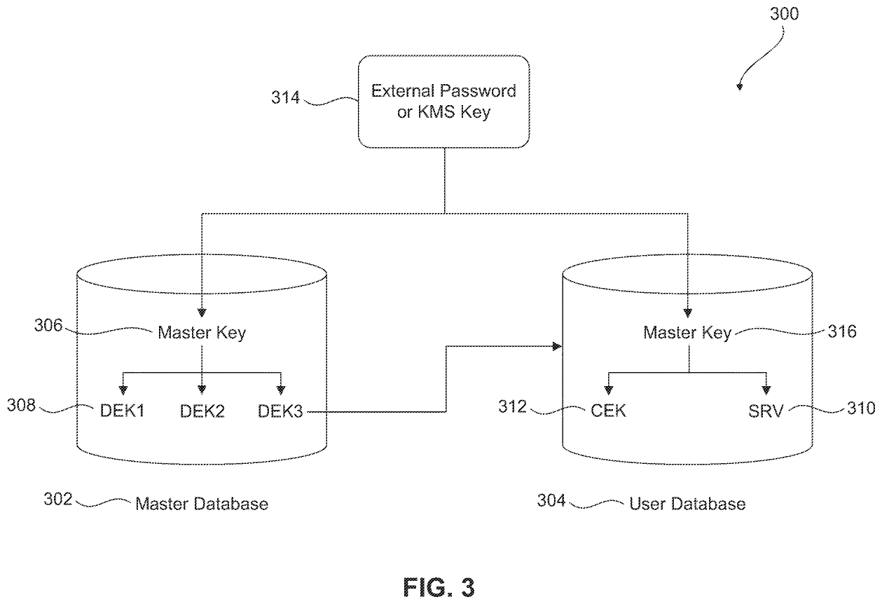

As discussed in more detail below with respect to FIGS. 3-7, processor 210 may implement different mechanisms for the self-sufficient encrypted database backup with respect to the system 100 of FIG. 1.

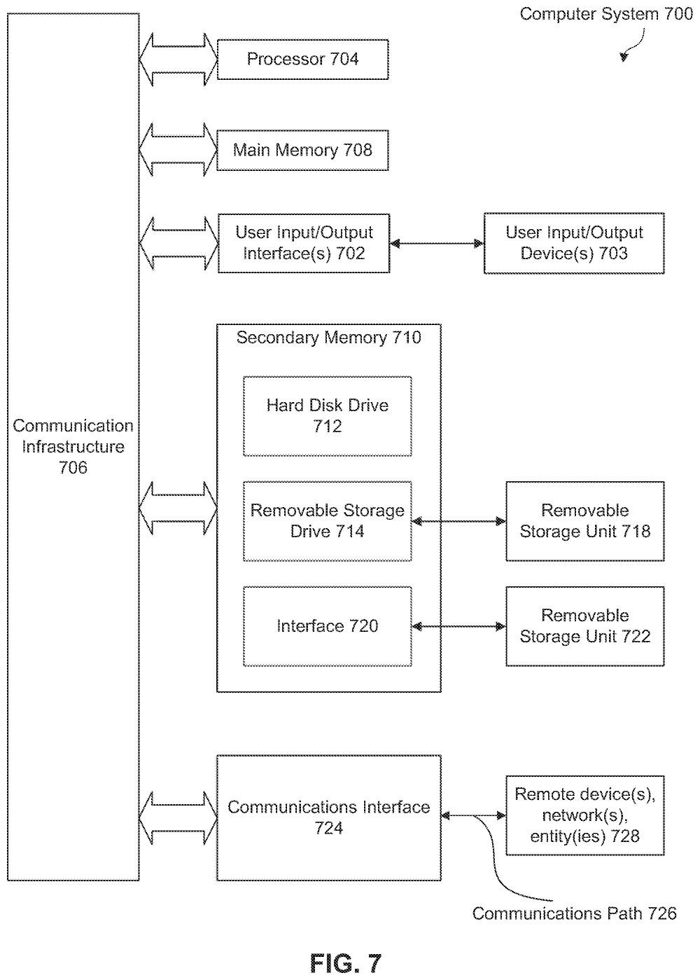

FIG. 3 illustrates an example system 300 of a key hierarchy structure of a database server, according to embodiments of the disclosure. As a convenience and not a limitation, FIG. 3 may be described with regard to elements of FIGS. 1, 2, and 7. The system 300 may represent the operation of devices (e.g., the database servers 104 and 106) implementing the self-sufficient encrypted database backup. The example system 300 may also be performed by the example system 200 of FIG. 2, controlled or implemented by processor 210, and/or computer system 700 of FIG. 7. But the system 300 is not limited to the specific embodiments depicted in those figures and other systems may be used to perform the method, as will be understood by those skilled in the art. It is to be appreciated that not all operations may be needed, and the operations may not be performed in the same order as shown in FIG. 3.

In some embodiments, the system 300 includes a master database 302 and a user database 304, The master database 302 can be the master database 112 of the database server 104 in FIG. 1, Similarly, the user database 304 can be the user database 114 of the database server 104 in the FIG. 1, A user database, such as the user database 304 may include two types of encryption keys: (1) data encryption keys, and (2) key encryption keys (KEKs). For example, the user database 304 may include one or more column encryption keys (CEKs) 312 and one or more service keys (SRVs) 310. In some embodiments, data of the user database 304 are stored in data columns and encrypted by the one or more CEKs 312, For example, data in a data column can be encrypted by at least one of the one or more CEKs. A CEK can also encrypt one or more data columns, Therefore, the one or more CEKs 312 are data encryption keys. The one or more SRVs 310 can be used to encrypt special types of data. For example, the one or more SRVs 310 can encrypt passwords of a secure sockets layer (SSL) of the user database 304. Thus, the one or more SRVs 310 are also data encryption keys. On the other hand, the user database 304 may also include one or more master keys 316, which can encrypt the one or more CEKs 312 and the one or more SRVs 310. Therefore, the one or more master keys 316 are key encryption keys.

In some embodiment, the master database 302 may include one or more master keys 306 and one or more database encryption keys (DEKs) 308, which are encrypted by the one or more master keys 306. At least one DEK of the one or more DEKs 308, such as the DEK3, is used to encrypt data of the user database 304 as a whole, which includes the encryption keys, the data columns, and the SSL passwords. In addition, the one or more master keys 316 can be encrypted by the one or more master keys 306. In such a case, the one or more master keys 316 can be first encrypted by the one or more master keys 306, and can then be encrypted along with other data of the user database 304 as a whole by the DEK3. Phrased differently, the one or more master keys 316 can be encrypted twice. In some embodiments, the one or more master keys 316 can be encrypted by external keys 314, such as external passwords or a key management service (KMS) key located outside the database server 104, instead of the one or more master keys 306.

FIG. 3 shows a hierarchy structure of encryption keys. For example, to retrieve information, such as information in the data columns, stored in the user database 304, several encryption keys are required, First, the DEK3 of the master database 302 is required to decrypt the data of the user database 304 as a whole. Second, the one or more master keys 306 or the external keys 314 are needed to decrypt the one or more master keys 316. Third, the one or more CEKs 312 are required and can be decrypted by the one or more master keys 316. Finally, the decrypted one or more CEKs 312 can be used to decrypt the data in the data columns and retrieve the information. Therefore, user database 304 connects with the master database 302 and/or the external keys 314 based on the hierarchy structure,

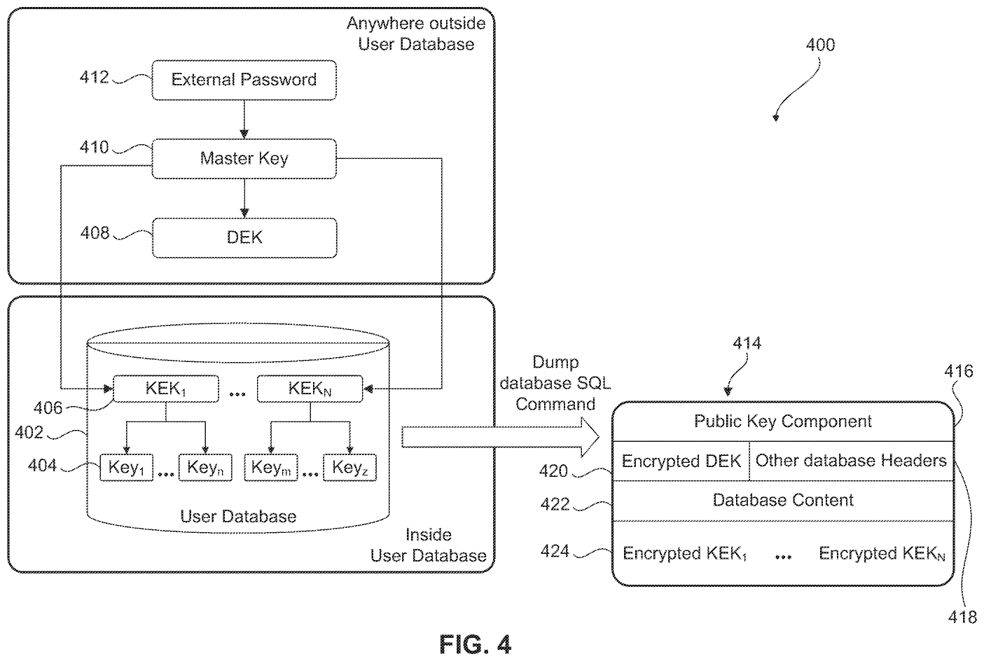

FIG. 4 illustrates an example system 400 of a database backup file, according to embodiments of the disclosure. As a convenience and not a limitation, FIG. 4 may be described with regard to elements of FIGS. 1, 2, and 7. The system 400 may represent the operation of devices (e.g., the database servers 104 and 106) implementing the self-sufficient encrypted database backup. The system 400 may also be performed by the example system 200 of FIG. 2, controlled or implemented by processor 210, and/or computer system 700 of FIG. 7. But the system 400 is not limited to the specific embodiments depicted in those figures and other systems may be used to perform the method, as will be understood by those skilled in the art. It is to be appreciated that not all operations may be needed, and the operations may not be performed in the same order as shown in FIG. 4.

In some embodiment, the system 400 may include a user database 402, which includes one or more KEKs 406 and one or more keys 404. The one or more KEKs 406 can be the one or more master keys 316 in FIG. 3, which can be used to encrypt the one or more keys 404. For example, KEK1 can be used to encrypt key1, key2, . . . , keyn and KEKN can be used to encrypt keym, . . . , keyz. The one or more keys 404 can be data encryption keys, such as the one or more CEKs 312 and the one or more SRVs 310 in FIG. 3, Similar to the hierarchy structure of encryption keys shown in FIG. 3, the one or more KEKs 406 can be encrypted by one or more master keys 410, such as the one or more master keys 306 in FIG. 3. The one or more KEKs 406 can also be encrypted by external keys 412, such as the external keys 314 in FIG. 3. In some embodiments, data stored in the user database 402 are encrypted as a whole using the one or more DEKs 408, The one or more DEKs 408 can be the one or more DEKs 308 in FIG. 3.

In some embodiments, a database server, such as the database server 104, can generate a database backup file based on a dump database command, such as a structured query language (SQL) dump command. For example, the SQL dump command can be “DUMP DATABASE <database name> PROTECT WITH <public key|public key file path|password> TO <dump file name>.” Upon receiving the dump database command, the database server generates a database backup file 414 in following steps.

First, the database server may locate a user database, such as the user database 402 or 304 based on the database name identified in the dump database command and generate database content 422 to include data stored in the user database as a whole.

Second, the database server may retrieve the one or more DEKs 408 that are used to encrypt the data of the user database; decrypt the one or more DEKs 408 using the one or more master keys 410; and re-encrypt the one or more DEKs 408 using a public key to generate encrypted DEKs 420. In other words, the database server changes the encryption of the one or more DEKs 408 from the one or more master keys 410 to the public key. The one or more DEKs 408 and the one or more master keys 410 may be located in a master database of the database server, such as the master database 302 or 112. In some embodiment, the database server re-encrypt the one or more DEKs 408 based on the dump database command. For example, the dump database command may identify the public key or a file path to the public key. The database may retrieve the public key and re-encrypt the one or more DEKs 408 using the public key. For another example, the dump database command may identify a password. In such a case, the database server may re-encrypt the one or more DEKs using the password. In some embodiment, the encrypted DEKs 420 are included in the database backup file 414 as a header.

Third, the database server may generate a key component 416 that includes the public key or the password identified by the dump database command.

Fourth, the database server may retrieve one or more KEKs 406; decrypt the one or more KEKs 406 using the one or more master keys 410 or the external keys 412; and re-encrypt the one or more KEKs 406 using the public key or the password identified by the dump database command to generate the encrypted KEKs 424. In some embodiment, the encrypted KEKs 424 are stored adjacent to the encrypted DEKs 420.

Finally, the database server generate other database headers 418 that may include information and metadata regarding the user database 402.

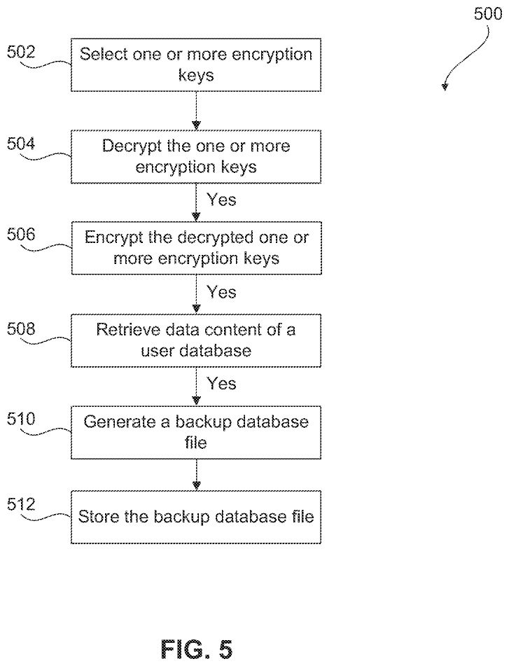

FIG. 5 illustrates an example method 500 for saving a database backup file, according to embodiments of the disclosure. As a convenience and not a limitation, FIG. may be described with regard to elements of FIGS. 1, 2, and 7. The method 500 may represent the operation of devices (e.g., the database servers 104 and 106) implementing the self-sufficient encrypted database backup. The method 500 may also be performed by the example system 200 of FIG. 2, controlled or implemented by processor 210, and/or computer system 700 of FIG. 7. But the method 500 is not limited to the specific embodiments depicted in those figures and other systems may be used to perform the method, as will be understood by those skilled in the art. It is to be appreciated that not all operations may be needed, and the operations may not be performed in the same order as shown in FIG. 5.

At 502, a database server, such as the database server 104, receives a dump database command from a user, such as the user 102. The dump database command may identify a user database as discussed above in FIG. 4. Based on the dump database command, the database server may select one or more encryption keys. In some embodiment, the database server may select two types of encryption keys. First, the database server may select inside encryption keys within the user database that are encrypted by outside encryption keys, Such inside encryption keys can be the one or more KEKs 106 in FIG. 4 and/or the one or more master keys 316 in FIG. 3. Second, the database server may select outside encryption keys that are located outside the user database and are used to encrypt data of the user database. Such outside encryption keys can be the one or more DEKs 408 in FIG. 4 and/or the one or more DEKs 308 in FIG. 3.

At 504, the database server may decrypt the one or more encryption keys. For example, the database server may decrypt the one or more KEKs 406 using the one or more master keys 410 or the external keys 412, The database server may also decrypt the one or more DEKs 408 using the one or more master keys 410.

At 506, the database server may re-encrypt the decrypted one or more encryption keys. In some embodiment, the database server may re-encrypt based on the dump database command. For example, the dump database command may identify a public key and the database server may re-encrypt the one or more decrypted encryption keys using the public key. The database server may also re-encrypt using a password identified by the dump database command. In some embodiment, by decrypting and re-encrypting the one or more encryption keys, the database server decomposes the hierarchy structure shown in FIGS. 3 and 4. For example, the one or more master keys 316 are no longer encrypted by one or more master keys 306 of the master database 302 or the external keys 314.

At 508, the database server may retrieve data content of the user database. In some embodiment, the database server retrieves the data content as a whole. For example, the user database can be the user database 304 and the data content may include the one or more master keys 316, the one or more CEKs 312, the one or more SRVs 310, the data columns, and the SSL passwords.

At 510, the database server may generate a database backup file based on the re-encrypted one or more encryption keys in 506 and the data content in 508. The database backup file may also include the public keys or the password identified by the dump database command. Finally, the database backup file may include other database headers, such as the database headers 418.

At 512, the database server may store the database backup file. The database server may store the database backup file locally in the database server. The database server may store the database backup file remotely in another database server, such as the database server 106, or in a cloud storage.

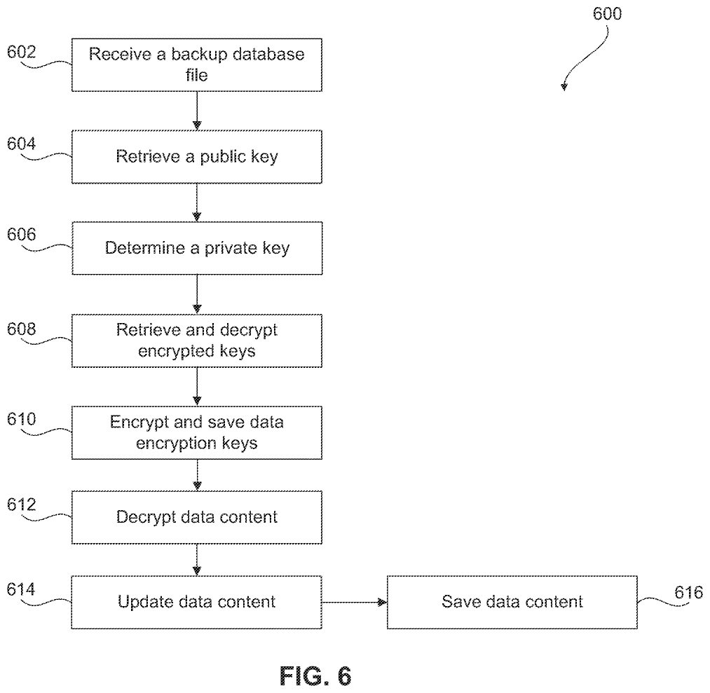

FIG. 6 illustrates an example method 600 for loading a database backup file, according to embodiments of the disclosure. As a convenience and not a limitation, FIG. 6 may be described with regard to elements of FIGS. 1, 2, and 7. The method 600 may represent the operation of devices (e.g., the database servers 104 and 106) implementing the self-sufficient encrypted database backup. The method 600 may also be performed by the example system 200 of FIG. 2, controlled or implemented by processor 210, and/or computer system 700 of FIG. 7. But the method 600 is not limited to the specific embodiments depicted in those figures and other systems may be used to perform the method, as will be understood by those skilled in the art. It is to be appreciated that not all operations may be needed, and the operations may not be performed in the same order as shown in FIG. 6.

At 602, a database server, such as the database servers 104 or 106, receives a database backup file. The database backup file can be the database backup file 414. In some embodiment, the database server may receive the database backup file based on a load database command, such as a load SQL command. For example, the load SQL command can be “LOAD DATABASE. <database name> RESTORE WITH <private key |private key file path|password> FROM <dump file location> [with override].” The database server may retrieve the database backup file based on the “dump file location” identified by the load database command. The dump file location can be within the database server, in another database server, or in a cloud storage. In some embodiments, the database server receives the load database command from a user, such as the users 102 or 108.

At 604, the database server may retrieve a public key from the database backup tile.

At 606, the database server may determine a private key. In some embodiment, the private key is identified by the load database command. The database server then determines whether the private key matches the public key in the asymmetric cryptography. If the private key matches the public key, the control moves to 608. Otherwise, the database server may determine a new private key and verify it. For example, the database server may store a plurality of private keys and the database server can verify whether one of the stored plurality of the private keys matches the public key. The database server may also notify the user by prompting messages to the user and request the user to provide a different private key to be verified.

At 608, the database server may retrieve and decrypt encrypted keys. In some embodiment, the encrypted keys can be the encrypted DEKs 420 and the encrypted KEKs 424 that are included in the database backup file and encrypted by the public key. The database server can decrypt the encrypted keys using the private key. Thus, the database server obtains plaintext encryption keys, such as the one or more DEKs 408 and the one or more KEKs 406 in the plaintext form.

At 610, the database server may encrypt data encryption keys. For example, the data encryption keys can be the one or more DEKs 408 that are decrypted in 608, The database server may retrieve one or more master keys from a master database of the database server and encrypt the data encryption keys. The database server may then save the encrypted data encryption keys in the master database of the database server. In some embodiment, this reconstructs a part of the hierarchy structure described in FIGS. 3 and 4. For example, the data content included in the database backup file is encrypted by the data encryption keys that are now stored in the master database. In other words, the database backup file is connected with the master database of the database server.

In some embodiment, the database server determines whether the encrypted data encryption keys conflict with other data encryption keys stored in the master database. For example, the encrypted data encryption keys and existing data encryption keys of the master database may have the same name. In such a case, the database server may check whether the load database command includes an overwrite option. If the load database command does include the overwrite option, the database server may overwrite the existing data encryption keys of the master database with the encrypted data encryption keys. On the other hand, if the load database command does not include the overwrite option, the database server may discard the database backup file and abort the loading operation. Alternatively, the database server may rename the encrypted data encryption keys and save the encrypted data encryption keys in the master database.

At 612, the database server may decrypt the data content included in the database backup file. The database server may decrypt the data content using the data encryption keys, such as the one or more DEKs 408.

At 614, the database server may update the data content to further reconstruct the hierarchy structure. In some embodiments, the data content includes data that are previously stored in a user database, such as the user database 402, as a whole. Therefore, the data content may include one or more KEKs, such as the one or more KEKs 406. In the hierarchy structure shown in FIG. 4, the one or more KEKs are encrypted by one or more master keys of a master database, such as the one or more master keys 410. However, the one or more KEKs included in the data content are not encrypted by one or more master keys of the master database of the database server. For example, the database server can be the database server 106, which receives the database backup file from the database server 104. In such a case, the one or more KEKs are encrypted by one or more master keys of the master database 112, not the master database 116. In other words, the one or more KEKs in the data content do not have a connection with the master database 116 of the database server 106, which does not comply with the hierarchy structure. For another example, the database server can be the database server 104 and retrieve the database backup file stored locally in the database server 104. In such a case, the one or more KEKs in the data content are encrypted by one or more master keys of a prior version of the master database 112. However, the master database 112 may be updated since the database backup file is generated and the one or more master keys in the master database 112 may have changed. In such a case, the one or more KEKs in the data content no longer have a connection with the master database 112.

In some embodiment, the database server can update the one or more KEKs to restore the connection. As shown in FIG. 4, the database backup file, such as the database backup file 414, includes one or more encrypted KEKs 424. The one or more encrypted KEKs 424 contain the same plaintext keys as the one or more KEKs included in the data content 422, but are encrypted differently. As discussed above, the one or more encrypted KEKs 424 are encrypted by the public keys or the password. The database server may obtain the plaintext keys of the one or more encrypted KEKs 424 by decrypting the one or more encrypted KEKs 424 using the private key or the password identified in the load database command. The database server may then retrieve one or more master keys of the master database of the database server and encrypt the plaintext keys of the one or more encrypted KEKs 424 using the one or more master keys. Finally, the database server can replace the one or more KEKs in the data content 422 with the encrypted plaintext keys of the one or more encrypted KEKs 424, In this way, the encrypted plaintext keys are connected with the master database of the database server, as the hierarchy structure of FIGS. 3 and 4 describe.

At 616, the database server may save the updated data content. For example, if the database server receives the load database command to restore a user database of the database server, the database server can replace data content of the user database with the update data content, lithe database server receives the load database command to migrate data included in the database backup file, the database server can create a new user database and save the updated data content in the new user database. In some embodiments, the database server may create the new user database based on information included in database headers of the database backup file, such as the database headers 418.

Various embodiments may be implemented, for example, using one or more computer systems, such as computer system 700 shown in FIG. 7. Computer system 700 may be any well-known computer capable of performing the functions described herein such as the database servers 104 and 106 of FIG. 1, or 200 of FIG. 2. Computer system 700 includes one or more processors (also called central processing units, or CPUs), such as a processor 704, Processor 704 is connected to a communication infrastructure 706 (e.g., a bus.) Computer system 700 also includes user input/output device(s) 703, such as monitors, keyboards, pointing devices, etc., that communicate with communication infrastructure 706 through user input/output interface(s) 702. Computer system 700 also includes a main or primary memory 708, such as random access memory (RAM). Main memory 708 may include one or more levels of cache. Main memory 708 has stored therein control logic computer software) and/or data.

Computer system 700 may also include one or more secondary storage devices or memory 710, Secondary memory 710 may include, for example, a hard disk drive 712 and/or a removable storage device or drive 711, Removable storage drive 714 may be a floppy disk drive, a magnetic tape drive, a compact disk drive, an optical storage device, tape backup device, and/or any other storage device/drive.

Removable storage drive 714 may interact with a removable storage unit 718, Removable storage unit 718 includes a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 reads from and/or writes to removable storage unit 718 in a well-known manner.

According to some embodiments, secondary memory 710 may include other means, instrumentalities or other approaches for allowing computer programs and/or other instructions and/or data to be accessed by computer system 700, Such means, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and which may include any combination of LANs, WANs, the Internet, etc, Control logic and/or data may be transmitted to and from computer system 700 via communication path 726.

The operations in the preceding embodiments may be implemented in a wide variety of configurations and architectures. Therefore, some or all of the operations in the preceding embodiments may be performed in hardware, in software or both. In some embodiments, a tangible, non-transitory apparatus or article of manufacture includes a tangible, non-transitory computer useable or readable medium having control logic (software) stored thereon is also referred to herein as a computer program product or program storage device. This includes, but is not limited to, computer system 700, main memory 708, secondary memory 710 and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of the disclosure using data processing devices, computer systems and/or computer architectures other than that shown in FIG. 7, In particular, embodiments may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary embodiments of the disclosure as contemplated by the inventor(s), and thus, are not intended to limit the disclosure or the appended claims in any way.

While the disclosure has been described herein with reference to exemplary embodiments for exemplary fields and applications, it should be understood that the disclosure is not limited thereto. Other embodiments and modifications thereto are possible, and are within the scope and spirit of the disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative embodiments may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the disclosure should not be limited by any of the above-described exemplary embodiments, but should be defined only in accordance with the following claims and their equivalents.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A system comprising:
a first database server comprising a first master database and a first user database, configured to:
select one or more encryption keys from the first master database and the first user database;
generate a database backup file based on data content of the first user database and the one or more encryption keys, wherein the data content is encrypted by at least one data encryption key of the one or more encryption keys; and
transmit the database backup file to a second database server; and
the second database server comprising a second master database and a second user database, configured to:
receive the database backup file from the first database server;
decrypt the data content of the first user database using the at least one data encryption key; and
generate data content of the second user database based on the one or more encryption keys and the decrypted data content of the first user database.

2. The system of claim 1, wherein to select the one or more encryption keys, the first database server is further configured to:
select at least one key encryption key from the first user database, wherein the at least one key encryption key is encrypted by a master key of the first master database; and
decrypt the at least one key encryption key using the master key of the first master database.

3. The system of claim 1, wherein to select the one or more encryption keys, the first database server is further configured to:
select the at least one data encryption key from the first master database, wherein the at least one data encryption key is encrypted by a master key of the first master database; and
decrypt the at least one data encryption key using the master key of the first master database.

4. The system of claim 1, wherein the first database server is further configured to:
encrypt the one or more encryption keys; and
generate the database backup file based on data content of the first user database and the encrypted one or more encryption keys.

5. The system of claim 4, wherein to encrypt the one or more encryption keys, the first database server is further configured to:
encrypt the one or more encryption keys using asymmetric cryptography.

6. The system of claim 5, wherein to encrypt the one or more encryption keys using asymmetric cryptography, the first database server is further configured to:
encrypt the one or more encryption keys using a public key,
wherein the database backup file further includes the public key or a file path of the public key.

7. The system of claim 6, wherein the second database server is further configured to:
retrieve the public key based on the database backup file;
determine a private key based on the public key; and
decrypt the one or more encryption keys using the private key.

8. The system of claim 1, wherein the second database server is further configured to:
determine a master key of the second master database;
encrypt the at least one data encryption key of the one or more encryption keys using the master key of the second master database; and
store the encrypted at least one data encryption key of the one or more encryption keys in the second master database.

9. The system of claim 1, wherein to generate the data content of the second user database, the second database server is further configured to:
determine a master key of the second master database;
retrieve a first key encryption key of the one or more encryption keys from the database backup file;
encrypt the first key encryption key using the master key of the second master database; and
update the data content by replacing a second key encryption key of the data content of the second user database with the first key encryption key.

10. The system of claim 9, wherein to generate the data content of the second user database, the second database server is further configured to:
encrypt the updated data content using the at least one data encryption key of the one or more encryption keys.

11. A database server, comprising:
a memory configured to store a master database and a user database; and
at least one processor coupled to the memory and configured to:
select one or more encryption keys from the master database and the user database;
encrypt the one or more encryption keys;
generate a database backup file based on data content of the user database and the encrypted one or more encryption keys, wherein the data content is encrypted by at least one data encryption key of the one or more encryption keys; and
store the database backup file in the memory.

12. The database server of claim 11, wherein to select the one or more encryption keys, the at least one processor is further configured to:
select at least one key encryption key from the user database, wherein the at least one key encryption key is encrypted by a master key of the master database; and
decrypt the at least one key encryption key using the master key of the master database.

13. The database server of claim 11, wherein to select the one or more encryption keys, the at least one processor is further configured to:
select the at least one data encryption key from the master database, wherein the at least one data encryption key is encrypted by a master key of the master database; and
decrypt the at least one data encryption key using the master key of the master database.

14. The database server of claim 11, wherein to encrypt the one or more encryption keys, the at least one processor is further configured to:
encrypt the one or more encryption keys using asymmetric cryptography.

15. The database server of claim 14, wherein to encrypt the one or more encryption keys using the asymmetric cryptography, the at least one processor is further configured to:
encrypt the one or more encryption keys using a public key,
wherein the database backup file further includes the public key or a file path of the public key.

16. A database server, comprising:
a memory configured to store a master database and a user database; and
at least one processor coupled to the memory and configured to:
receive a database backup file, wherein the database backup file includes data content and one or more encryption keys of a prior version of the database server or a second database server, wherein the data content is encrypted by at least one data encryption key of the one or more encryption keys;
decrypt the data content using the at least one data encryption key of the one or more encryption keys;
generate an updated data content of the user database based on the one or more encryption keys and the decrypted data content; and
store the updated data content in the user database.

17. The database server of claim 16, wherein the one or more encryption keys are encrypted by a public key, wherein the database backup file includes the public key or a file path of the public key, wherein the at least one processor is further configured to:
retrieve the public key based on the database backup file;
determine a private key based on the public key; and
decrypt the one or more encryption keys using the private key.

18. The database server of claim 16, wherein the at least one processor is configured to:
determine a master key of the master database;
encrypt the at least one data encryption key of the one or more encryption keys using the master key of the master database; and
store the encrypted at least one data encryption key of the one or more encryption keys in the master database.

19. The database server of claim 16, wherein to generate the updated data content of the user database, the at least one processor is further configured to:
determine a master key of the master database;
retrieve a first key encryption key of the one or more encryption keys from the database backup file;
encrypt the first key encryption key using the master key of the master database; and
update the data content by replacing a second key encryption key of the data content with the first key encryption key.

20. The database server of claim 19, wherein to generate the updated data content of the user database, the at least one processor is further configured to:
encrypt the updated data content using the at least one data encryption key of the one or more encryption keys.
